(19) United States
(12) Patent Application Publication
(10) Pub. No.: US 2023/0266061 A1
(43) Pub. Date: Aug. 24, 2023

(54) Fuel Gas Conditioning System and Process to Improve Output Gas Quality

(71) Applicant: Pioneer Energy, Lakewood, CO (US)

(72) Inventors: Gevorg SARGSYAN, Lakewood, CO (US); Stevin GARCIA, Lakewood, CO (US); Eyal ARONOFF, Lakewood, CO (US)

(73) Assignee: Pioneer Energy, Lakewood, CO (US)

(21) Appl. No.: 17/679,474

(22) Filed: Feb. 24, 2022

(51) Int. Cl. F25J 3/06

(52) U.S. Cl. CPC F25J 3/0635; F25J 3/062; F25J 3/0695; F25J 2205/02; F25J 2210/04; F25J 2270/90; F25J 2240/40

(57) ABSTRACT

The invention relates to a refrigeration system that in mode 1 prepares a reservoir of cooled refrigerant before flowing unconditioned gas through the system, and in mode 2, continuously cools feed gas with the prepared refrigerant inventory, extracting natural gas liquids (NGLs) comprising predominantly ethane, propane, butane, and condensate and controlled by a control system without needing ramp up time.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS-REFERENCE TO RELATED APPLICATIONS

“This application claims the benefit of U.S. Provisional Patent Application No. 63/153,065, filed on Feb. 24, 2021 and No. 63/249,167 filed on Sep. 28, 2021, which are incorporated by reference herein in its entirety.”

### BACKGROUND OF THE INVENTION

### 1) Field of the Invention

The invention relates to the field of oil and gas production. New and rich sources of petroleum and natural gas discovered recently have alleviated concerns of availability and turned the industry's focus to sustainable and economic production technologies. Important goals now being pursued are to address environmental impacts such as flaring, emissions reduction and other factors to meet or exceed Environmental, Social and Governance (ESG) expectations.

In remote well site operations, one of the principal costs and logistical challenges facing well service operators is the provision of fuel for engines that drive the hydraulic fracturing equipment. In fact, fuel costs can account for 20% of well completion costs. Typically, liquid fuel such as diesel fuel is trucked in as needed. This results in significant cost, and both logistical and environment issues at the well head site.

A typical fracking operation can consume upwards of 30,000 gallons of diesel a day, fed to the pumps on a continuous basis. It is delivered to the site via a fleet of diesel tankers operating nearly 24 hours a day for two to three weeks per location. Once the fracking operation is complete, the entire fleet is relocated to a different pad and the process resumes.

Typical turnaround time of a pump fleet, meaning the time it takes for a fleet to be disassembled on one site, transported to the next, setup and commissioned, is 48 hours.

To improve economics and reduce the environmental impact of fracking, many owners of hydraulic fracking fleets converted their fleet of pumps to dual fuel operation. This provides them the flexibility to fuel these engines with natural gas, replacing some of the diesel fuel.

Diesel replacement in a dual fuel fracking fleet can range from 50% to 85% of the fuel consumed by the engine at a given moment in time.

The dual fuel pumps require a high-quality gas supply or risk damaging the engines. The quality of the gas is measured by its methane number and btu/cf. High-quality gas has a lower heating value (LHV) of about 1,000 btu/cf. The quality of the gas deteriorates with as the LHV increases.

Fracking pump fleet owners have tried to use compressed natural gas (CNG) to fuel the pumps, but the logistics and the cost of CNG operations all but eliminates the economic value of replacing the diesel fuel.

Located near to most fracking operations, there are existing pipelines and producing wells that could be a source for the needed fuel gas; however, they produce high btu/cf “wet” associated gas which is unsuitable for use in gas engines.

Several attempts have been made to condition produced gas in the field to improve its quality and meet the needs of the engines. Several factors have contributed to the failure of these attempts.

A normal fracking fleet contains 12-18 pumps. All the pumps work together to provide the pressurized liquids needed for fracturing one well. As a result, they ramp up and down together. When the pumps all start up, they draw a large amount of gas rapidly from the gas conditioning system, causing the system to fail. That failure can result in slugs of high btu/cf liquids to be discharged from the conditioning system and foul the engines, which can lead to catastrophic engine failure. Variable fuel draw rate is one of the main reasons gas conditioning in the field has so far failed to capture traction.

Gas conditioning systems are very much like gas processing plants. The process is typically complex, and traditionally involves connecting several systems together. Setting up a gas plant can take several months. Setting up a small pre-fabricated gas plant can take several weeks, but the fracking fleets mobilize between jobs in as little as 48 hours. What is needed is a completely mobile gas plant system.

The fracking fleet operates one hydraulic fracturing segment at a time. This means that operationally, the fracking fleet alternates between operating at full capacity and idling. When the pumps rev up operation, they demand a large amount of conditioned gas over a short period. Traditional fuel conditioning solutions struggle to keep up with such a rapid increase in demand which results in liquid and water breaking through the gas conditioning system and getting injected into the engine which can cause catastrophic engine failure.

A breakthrough of liquid hydrocarbons and/or water out of the gas conditioning equipment is called slugging.

The fracking fleet operates in different basins and in different parts of each basin. In different basins and sometimes in different parts of each basin the gas composition available for use on site can vary greatly. This creates a situation for a gas conditioning system that is sufficient for treating the gas in one part of a basin, but does not have enough refrigeration capacity to deal with the gas in another part of the basin, particularly if that gas is rich with heavier hydrocarbon molecules.

A system that can handle the rapid increase and decrease of demand for conditioned gas while minimizing the chance of slugging and also handling a wide range of input gas composition while maintaining a high-quality output would be an ideal solution for fuel gas conditioning that support dual fuel fracking fleet operations.

### BRIEF SUMMARY OF THE INVENTION

The instant invention in one form is directed to a bimodal or trimodal refrigeration system that in mode 1, prepares a reservoir of cooled refrigerant before flowing unconditioned gas through the system, and in mode 2, continuously cools feed gas with the prepared refrigerant inventory, extracting natural gas liquids (NGLs) comprising predominantly ethane, propane, butane, and condensate without needing ramp up time.

The invention in another form is the integration of three different features (pre-cooled refrigerant, the recycle system and optionally using the NGLs as an additional refrigerant) into one apparatus under one control system to provide consistent fuel gas quality during frequent shutdown and startup of demand.

Using a prepared refrigerant inventory as a reservoir of cooling before any load is applied to the refrigeration system ensures that a rapid increase of demand for conditioned gas that is typical for frack fleet pumps operation does not result in breakthrough of unconditioned gas, hydrocarbon liquids, or water into the output of the system, preventing slugging.

An optional third refrigeration step uses the NGLs extracted in the first two steps as a refrigerant to extract even more NGLs from the gas and produce an even higher quality dry gas even when the input gas is rich in heavier hydrocarbons.

In the preferred embodiment, the system is located on a single trailer mounted skid for fast deployment and redeployment.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows an example of a process flow diagram of an infield, wet gas, fuel gas conditioning system.

FIG. 2 shows a simplified block flow diagram of the system and method.

FIG. 3 shows the typical process flowchart.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The instant invention is a system to condition gas by removing natural gas liquids from said gas, such that said conditioned gas can be effectively used for fueling rotating equipment such as, compressors, generators, oil field equipment, fracking pump fleets or drilling rigs comprising:
a. an inlet mixer that mixes freeze suppressant or hydrate inhibitor into the feed stream;
b. at least one refrigeration system with at least one of the refrigeration systems being a mechanical refrigeration system with pre-cooled refrigerant reservoir and a flooded evaporator;
c. a phase separator to separate hydrocarbon liquid and aqueous phases from hydrocarbon vapor phase;
d. a recycle system to route a slip stream from the conditioned gas back to the input of the system; and
e. a control system.

The condition gas forms a mixed gas stream with both gas, aqueous liquids and natural gas liquids and other hydrocarbon liquids.

The gas which is normally conditioned by the instant invention includes wellhead gas, field gas, gas from midstream gathering lines, residue gas, and produced gas.

The refrigeration system in many applications uses more than one refrigeration step; a common embodiment is a first refrigeration step, a second refrigeration step and a third refrigeration step. The first refrigeration step using the cold output conditioned gas to pre-chill the incoming gas to 20 degrees C. to −20 degrees C. The second refrigeration step using a mechanical refrigeration system with an optional pre-cooled refrigerant reservoir and a flooded evaporator to chill the incoming gas to 0 degrees C. to −40 degrees C. The third refrigeration step flashes the condensed hydrocarbon liquids from the second refrigeration system further cooling the gas and condensing more hydrocarbon liquids to −20 degrees C. to −70 degrees C.;

Ideally the system is such that it can be mounted on at least one skid or trailer. However other types of installations are anticipated by the instant invention.

The refrigeration step is preferably selected from the group consisting of a heat exchanger, an evaporator, a Joule Thomson valve, a turbo expander, and a mechanical refrigeration system.

The instant invention can also be described as a method of using a series of devices to condition natural gas to form a gas which can be oxidized in an internal combustion engine, fueling rotating equipment or other device. The gas can have numerous components including but not limited to various gas components such as hydrogen, helium, oxygen, nitrogen or other gas, aqueous liquids and natural gas liquids and other hydrocarbon liquids. The devices utilized in the process to condition natural gas to form a gas which can be oxidized in an internal combustion engine, can be any device which can achieve the desired thermodynamic and processing parameters. The natural gas is conditioned by removing natural gas liquids from the gas thereby forming a conditioned gas, the method comprising:
a) Step 1 the mixed hydrocarbon natural gas stream is mixed with freeze suppressant or hydrate inhibitor;
b) Step 1A the percentage of freeze suppressant can be selected from 0% to 100% and preferably the percentage is determined to suppress freezing of the hydrocarbon natural gas stream and the percentage of the hydrate inhibitor can be selected from 0% to 100% and preferably the percentage is determined to control the formation of hydrates during natural gas production for the natural gas condensate of the hydrocarbon natural gas stream;
c) Step 2 pass the natural gas to at least one variable capacity refrigeration system;
d) Step 2a the refrigeration system refrigerates a refrigerant gas converting it into liquid even before there is any natural gas flowing through the system;
e) Step 2b the pre-cooled liquid is stored in a reservoir or a surge tank;
f) Step 2c pass the natural gas through a heat exchanger such that it flows through the system and it exchanges heat with the refrigerant in the heat exchanger;
g) Step 2d the natural gas causes the refrigerant in the heat exchanger to boil, transferring cooling duty to the natural gas;
h) Step 2e the system utilizes additional refrigerant liquid from the reservoir and it is siphoned to the heat exchanger to replace the evaporated refrigerant faster than the speed at which the refrigeration system can react to change in said natural gas flow and refrigeration capacity demand, thereby providing consistent refrigeration capacity even if demand for refrigeration spikes quickly;
i) Step 2f when the initial refrigeration capacity demand spike is over, the variable refrigeration system automatically adjusts to provide enough refrigeration capacity needed to refrigerate the steady state demand;
j) Step 3 the refrigerated natural gas from Step 2 is passed to a phase separator to separate liquid and aqueous phases from vapor phase;
k) Step 4 the slip stream from the vapor phase is circulated back to the inlet of the system to provide load and reduce the NGL content of the input gas when the demand for conditioned gas is low;
l) Step 6 the system is automated through the use of a control system that controls the variable capacity refrigeration system described above.

The method can also have an additional step where refrigeration flashes the condensed hydrocarbon liquid stream rich in NGLs from the variable refrigeration step through an expansion valve or a Joule Thomson valve into at least one separator.

The method can also have an additional step where the separator is selected from the group consisting of a vertical separator, horizontal separator, cyclonic separator, two-phase separator, three-phase separator, membrane separator, an absorption/desorption separator and any combination thereof.

The method hydrate and freeze formation inhibition process can use an antifreeze and preferably the antifreeze is selected from the group consisting of methanol liquid, or vaporized methanol, or with desiccant such as molecular sieve, or with glycols such as ethylene glycol (EG) and triethylene glycol (TEG).

The refrigeration used in the process is preferably selected from the group consisting of commercial refrigerant, propane refrigerant, R290 and combination of refrigerants.

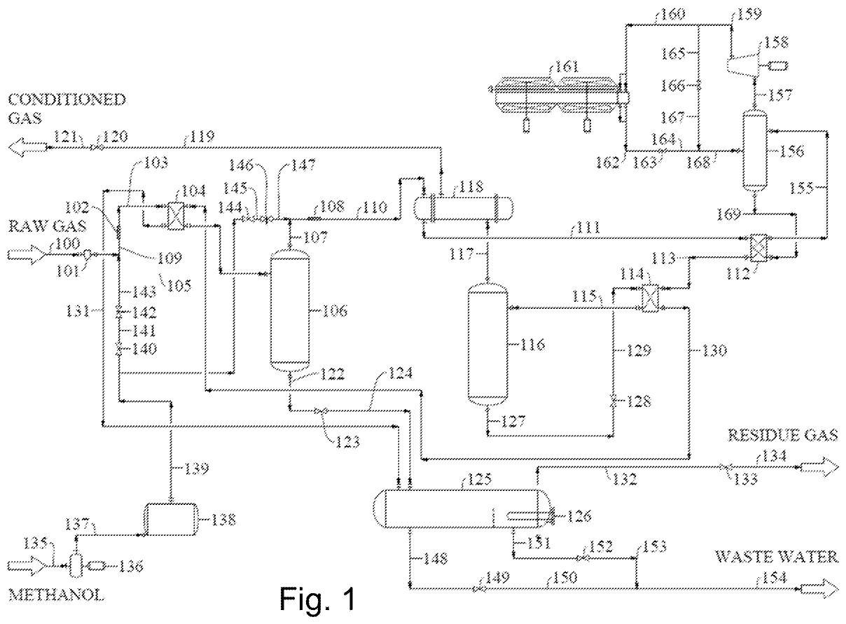

Referring now to the drawings FIGS. 1-3, and more particularly to FIG. 1, there is shown a system that conditions feed gas of varying energy contents into a suitable quality fuel gas by mechanical refrigeration, NGL refrigeration, and outlet gas economizing.

FIG. 1 shows the feed gas [100] passes through an inlet filter [101] to remove large particulate matter from the stream. An inline mixer [102] mixes freeze suppressant/hydrate inhibitor [143] with the feed stream.

A methanol stream [135] is pumped [136] into a holding vessel [138] and injected in liquid form [139] as a freeze suppressant and hydrate inhibitor.

A methanol stream is pumped [136] into a heated tank [138] and boiled. Vaporized methanol [139] is injected as a freeze suppressant and hydrate inhibitor.

In another embodiment, a methanol stream is pumped [136] into a heated tank [138] at elevated pressure and heated near its saturation temperature for use as a freeze suppressant and hydrate inhibitor [139]. Upon injection, a portion of the methanol stream vaporizes.

In another embodiment, a kinetic hydrate inhibitor [135] is pumped [136] into a holding vessel [138] and injected in liquid form [139] into the system.

Diverting valves [140] and [144] direct the freeze suppressant/hydrate inhibitor to different areas in the process.

Flow control valves [142] and [146] continuously modulate based on process freeze suppression/hydrate inhibition requirements.

In another embodiment, flow control valves [142] and [146] are set at a fixed value and deliver a specified amount of freeze suppressant/hydrate inhibitor.

The mixed stream [103] enters the tube side of a shell and tube heat exchanger [104], where it is cooled by incoming NGLs [130] on the shell side.

In another embodiment, the mixed stream [103] enters the hot side of a plate heat exchanger and is cooled by incoming NGLs [130] on the cold side.

The cooled feed [105] enters a phase separator [106] where liquid and aqueous phases [122] are metered through a level control valve [123] into a low-pressure residue phase separator [125]. The vapor phase [107] leaving the phase separator [106] mixes with freeze suppressant/hydrate inhibitor [147]. An inline mixer [108] shortens the required mixing length. The mixed stream [110] is cooled by cold conditioned gas [117] in a heat exchanger [118]. The cooled stream [117] is further cooled by a mechanical refrigeration system [155-169] in an evaporator [112].

The refrigeration evaporator [112] is a flooded evaporator to thermally ground the evaporator hot side, reducing temperature and gas quality fluctuations.

In another embodiment, the refrigeration evaporator [112] is a direct injection style evaporator.

The refrigerated gas [113] is further cooled by evaporating NGLs [129] in a heat exchanger [114]. The cooled stream [115] is fed directly to a phase separator [116].

In another embodiment, the cooled two-phase stream [115] is fed through a valve to drop pressure and vaporize a portion of the liquid phase, further cooling the gas and improving conditioned gas quality.

NGLs [127] flow through a level control valve [128] to a lower pressure [129] where they are used to cool the refrigerated gas stream [113]. Remaining cold NGLs [130] proceed to the feed heat exchanger [104] where they cool the feed gas stream [103]. The remaining two-phase mixture [131] flows directly into a low-pressure residue phase separator [125].

Cold gas [117] leaving the cold phase separator [116] exchange against pre-chilled incoming gas [110] in a heat exchanger [118]. Warm conditioned gas [119] flows through a pressure control valve [120] to outlet as conditioned gas at a specified pressure [121].

Water [148] in the low-pressure residue phase separator [125] is removed through a level control valve [149]. Remaining NGLs spill over a weir inside the phase separator to a heated section [126] in the phase separator.

The heater [126] drives off volatile components in the NGLs as residue gas [132], which is metered through a pressure control valve [133] to the residue gas outlet [134]. Remaining non-volatile NGLs [151] are removed through a level control valve [152] and mixed with the wastewater stream [154].

In another embodiment, the heater [126] does not heat the liquids and volatile NGLs remain in the liquid phase.

A compressor [158], an air-cooled condenser [161], a control valve [163], a surge drum [156], and an evaporator [112] comprise a refrigeration system.

During normal operation, refrigerant is discharged [159] from the compressor [158] and fed to an air-cooled condenser [161]. High pressure liquid refrigerant [162] exits the condenser and is metered through an expansion valve [163]. Refrigerant phases are separated in a surge drum [156].

Low pressure liquid refrigerant [169] flows to the evaporator [112] by thermosiphon action, where process heat load evaporates the refrigerant. Refrigerant vapor [155] returns to the surge drum [156]. Refrigerant vapor [157] from the surge drum [156] feed the suction side of the compressor [158] to complete the refrigerant loop.

To maintain an inventory of low-pressure liquid refrigerant in the surize drum [156], the refrigeration compressor [158] must continuously operate. During periods of no/low process flow, the process heat load in the evaporator [112] is low. Low process heat load results in low vapor [169] production in the evaporator [112], and a corresponding decrease in compressor suction [157] pressure. Damage to compression equipment and oil degradation occur if the suction pressure drops too low, so refrigeration systems are equipped with a low-pressure cutoff switch to prevent equipment damage.

A slipstream of hot refrigerant discharge gas [165] is circulated through a valve [166] into the surge drum [156] to maintain suction pressure under low process load. The heat from the hot refrigerant discharge gas [165] vaporizes a portion of the low-pressure liquid refrigerant reservoir, providing sufficient suction pressure for the compressor [158] to continue operation.

In another embodiment, an immersion heater in the surge drum [156] provides the energy necessary to vaporize the refrigerant.

The condenser [161] and expansion valve [163] continue to operate and maintain the low-pressure liquid refrigerant reservoir.

The compressor [158] may operate at reduced capacity to reduce the amount of hot refrigerant [165] required to maintain adequate suction pressure.

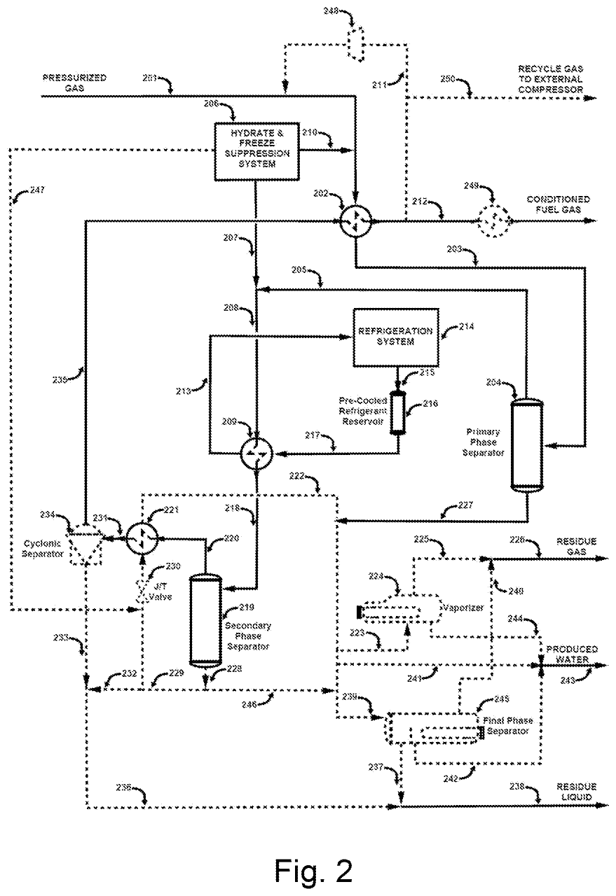

FIG. 2 shows a block flow diagram demonstrating the principals of the system. Unconditioned pressurized hydrocarbon rich gas [201] enters the system. This stream may contain water and/or liquid hydrocarbons. To prevent freezing or hydrate formation, a freeze suppressant [206] may be injected into the incoming stream [210]. The incoming stream may be cooled by zero, one or more heat exchangers, known as economizing heat exchanger(s) [202]. The [202] heat exchanger(s) both cools down the incoming gas and warms up the outgoing gas [212]. The cooled gas goes to zero, one or more primary separator(s) [204] to separate the liquid hydrocarbons and liquid water from the gaseous hydrocarbons and gaseous water. The liquid phase [227] coming out of the primary separator [204] can be directed [241] to the produced water evacuation [243], or to one or more vaporizers [224], or to one or more phase separators [245]. The water phase [244] from the vaporizer(s) [224] can be directed to the produced water evacuation [243]. The water phase [242] from the final phase separator(s), can be directed to the produced water evacuation [243].

The gaseous hydrocarbon stream [225] that is produced by the vaporizer(s) is a residue gas rich with longer chain hydrocarbons [226]. If one or more final phase separator(s) [245] are used, the gaseous phase produced by that separator [240] is also produced as residue gas [226]. The liquid hydrocarbon phase [237] produced by the final phase separator [245], is evacuated as Natural Gas Liquids (NGLs). The final phase separator [245] may have zero, one or more reboiler(s) or heating element(s) to drive the lighter hydrocarbon molecules out of the NGLs product. The lighter hydrocarbon molecules [240] are evacuated as residue gas.

The gaseous hydrocarbon stream [205] produced by the primary phase separator [204] may be mixed with a freeze suppressor [207]. The gas is then refrigerated by heat exchanger [209] with a refrigerant [217].

The refrigeration system [214], can refrigerate the refrigerant even when there is no load on the system. The refrigerated refrigerant [215] is stored in one or more pre-cooled refrigerant reservoir [216]. When there is demand for conditioned gas, and gas is flowing through the system, the initial gas going through the evaporator heat exchanger [209] will boil the liquid refrigerant in the heat exchanger. That refrigerant will be replenished by pre-cooled refrigerant from the reservoir [216] providing consistent refrigeration. If demand for conditioned gas rises rapidly, particularly if it rises faster than the ability of the refrigeration system to rev up, the flooded evaporator [209] will provide the needed refrigeration capacity resulting in a consistent quality of output conditioned gas [212].

The refrigerated hydrocarbon stream [218] now contains both condensed liquid and hydrocarbon gas. This mixed phase stream [218] is injected to zero, one or more separator [219]. The liquid phase [228] produced by the phase separator(s) [219], may be routed directly to the liquid hydrocarbon stream [232, 236, 238] and/or it may be routed [246] to the vaporizer [224] or to the final phase separator [245].

The liquid phase [228] produced by the phase separator(s) [219], may be mixed with a freezing suppressant [247] and pass through one or more expansion valves and or J/T valve [230]. As the pressure is reduced through the expansion valve [230] the hydrocarbon liquid expands, some of it may evaporate creating cooling duty. In effect the liquid hydrocarbon stream rich with NGLs is used as a refrigerant to further cool the outgoing conditioned gas [220], through heat exchanger [221]. The NGL rich gas [222] may be routed to vaporizer(s) [224] or to the final phase separator [245].

The cooled gas [231] then goes to zero, one or more phase separator [234]. In one embodiment that phase separator is a cyclonic separator [234]. The condensed liquid hydrocarbon stream [233], may be routed to liquid hydrocarbon evacuation [238], or to the vaporizer [224] or to the final phase separator [245]. The cold conditioned gas [235] then goes through zero, one or more heat exchanger(s) [202], known as an economizer heat exchanger(s), to warm up while cooling the incoming gas [201]. The warmed conditioned gas is supplied as fuel [212].

Some of the conditioned gas [211] may be directed back through one or more compressor [248] to mix with the input raw gas stream. The compressor may be dedicated to the recycled gas [211] or may be part of the supply of the pressurized gas supply [201]. The recycled gas provides load when there is no demand for gas from the system enabling the system to continue to operate even when there is no demand. Also being that the recycled gas is conditioned, it lowers the btu of the incoming gas, improving the quality of the gas drawn from the system, especially in the initial draw further improving the quality of the gas produced by the system and eliminating slugging.

Refrigerant selection determines suction and discharge pressures as well as temperatures attainable in the evaporator. For example, using propane as a refrigerant at a suction pressure of 1.5 bara, the evaporator temperature is approximately −34° C. as this is the saturation temperature of propane at this pressure. The discharge pressure must be roughly 20 bara for propane to be reliably condensed using ambient air as a cooling medium. Temperature and pressure ranges are similar for propylene and R-32 (difluoromethane).

The reservoir [216] volume should be large enough to cool the process gas until the rest of the refrigeration system can stabilize. The required volume varies based on throughput of the process and refrigeration system dynamics Assuming a stabilization time of 3 minutes and a process throughput of 4 MMscfd of 1320 btu/scf HHV gas, the propane refrigerant inventory would have to be at least 26 gallons of saturated liquid propane at 1.5 bara.

For a refrigeration system using R-32 as the refrigerant with similar process conditions and refrigeration system dynamics, the reservoir must be at least 15 gallons of saturated liquid R-32 at 2.5 bara. In other preferred embodiments the volume of the refrigerant reservoir may be 2, 3 4, or 5 times the reservoir calculated capacity value to accommodate for contingency process conditions.

When process load rapidly increases, the continuously operated refrigeration system maintaining a low-pressure liquid refrigerant reservoir can adjust to the changing process demands more rapidly than intermittently operated refrigeration system or continuously operated refrigeration systems lacking a low-pressure liquid refrigerant reservoir.

Each one of the separator(s) may be, but not limited to, vertical separator(s), horizontal separator(s), cyclonic separator(s), two-phase separator(s), three-phase separator(s), membrane separator(s), and/or absorption/desorption separator(s) and any combination thereof.

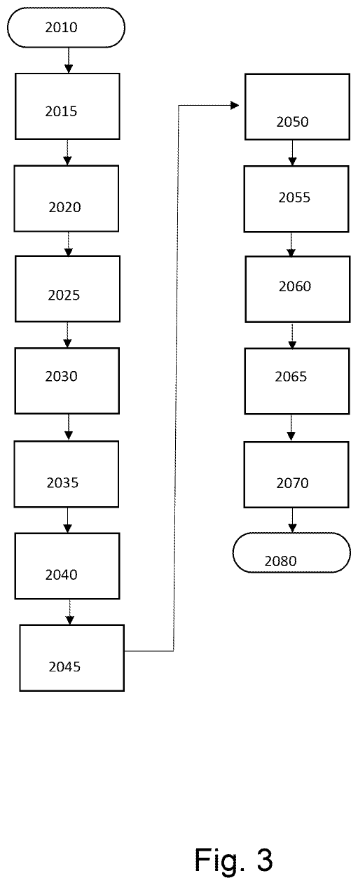

The process is shown in FIG. 3

A method of using the device of claim 1 wherein, the natural gas is conditioned by removing natural gas liquids from said gas forming a condition gas, the method comprising:
a. Step [2010] is the start of the process.
b. Step [2015] the natural gas comprises a mix of hydrocarbon natural gas stream and said natural gas is mixed with a freeze suppressant and a hydrate inhibitor;
c. Step [2020] the percentage of freeze suppressant can be selected from 0 to 100% and the percentage of the hydrate inhibitor can be selected from 0 to 100% of the hydrocarbon natural gas stream;
d. Step [2025] comprises of passing said natural gas to at least one variable capacity refrigeration system;
e. Step [2030] comprises of the said refrigeration system refrigerates a refrigerant gas converting it into liquid even before there is any natural gas flowing through the system;
f. Step [2035] comprises of the said pre-cooled liquid is stored in a reservoir or a surge tank;
g. Step [2040] where when natural gas flows through the system it exchanges heat with the refrigerant in a heat exchanger;
h. Step [2045] where said natural gas causes the refrigerant in the heat exchanger to boil, transferring cooling duty to said natural gas;
i. Step [2050] where additional refrigerant liquid from the reservoir is siphoned to the heat exchanger to replace the evaporated refrigerant faster than the speed at which the refrigeration system can react to change in said natural gas flow and refrigeration capacity demand, thereby providing consistent refrigeration capacity even if demand for refrigeration spikes quickly;
j. Step [2055] when the initial refrigeration capacity demand spike is over the variable refrigeration system automatically adjust to provide enough refrigeration capacity needed to refrigerate the steady state demand;
k. Step [2060] comprises of passing said refrigerated natural gas from Step 2 to at least one phase separator to separate liquid and aqueous phases from vapor phase;
l. Step [2065] comprising of a slip stream from the said vapor phase that is circulated back to the inlet of the system to provide load and reduce the NGL content of the input gas when the demand for conditioned gas is low;
m. Step [2070] the control system that controls the variable capacity refrigeration system used in steps—2065 so as to remove as much of the liquid as it can from the mix of hydrocarbon natural gas stream.
n. Step [2080] is the end of the process.

In the preferred embodiment of the system, a single trailer mounted skid contains a hydrate and freeze inhibition system; a mechanical refrigeration system to cool the gas enough for NGLs to condense out of it; and a cooling system that flashes the NGLs and exchanges them against the treated gas, further sub-cooling it and condensing additional NGLs from it; and a heat exchanger to pre-cool the incoming gas with the outgoing gas.

In one embodiment, the system is skid mounted without a trailer.

In one embodiment, subsystems are skid mounted independently.

In one embodiment, the hydrate and freeze inhibition system uses methanol or other antifreeze liquid to prevent moisture in the gas from freezing and from forming hydrates.

In another embodiment of the system, the hydrate and freeze inhibition system uses molecular sieve or other desiccant to dehydrate the gas.

In another embodiment of the system, the hydrate and freeze inhibition system uses glycols such as ethylene glycol (EG) and triethylene glycol (TEG) to dehydrate the gas.

In one embodiment, the mechanical refrigeration step uses propane (R290) as a refrigerant.

In another embodiment, the mechanical refrigeration step uses commercial refrigerant such as an HFC, propene, R-32, other single component refrigerant, or a refrigerant blend.

In another embodiment, the mechanical refrigeration step uses a Joule-Thompson valve.

In one embodiment, the cold conditioned gas is passed through a heat exchanger with the incoming gas.

In one embodiment, the pressure of the system ranges from 80 psi to 600 psi.

In one embodiment, the refrigeration of the first step ranges from 15° C. to −70° C.

In one embodiment, the cooling step ranges between 10° C. and −70° C.

In one embodiment, the output gas methane number is greater than 65.

In one embodiment, the mechanical refrigeration step is capable of running without an external load to generate a reservoir of low-pressure liquid refrigerant.

In one embodiment, the mechanical refrigeration step continues to run using hot compressor discharge gas to vaporize a portion of the liquid refrigerant.

In another embodiment, the mechanical refrigeration step continues to run using an electric heater to vaporize a portion of the liquid refrigerant.

In one embodiment, refrigerant is stored as a liquid for transportation.

In one embodiment, an expansion valve decreases the process gas pressure prior to final separation to improve gas quality on startup.

In one embodiment, the refrigeration system uses a single compressor.

In another embodiment, the refrigeration system uses multiple compressors.

In one embodiment, the refrigeration system uses a flash economizer to improve performance.

In another embodiment, an economizing heat exchanger flashes high pressure refrigerant and returns it to intermediate pressure to economize the refrigeration cycle.

In one embodiment, the refrigeration condenser is entirely air cooled.

In another embodiment, the refrigeration condenser cooling is augmented with cool process gas.

In one embodiment, the condenser fans run at a fixed frequency and cooling duty is modulated with louvers.

In another embodiment, the condenser fans run at a variable speed using a VFD.

In another embodiment, the condenser fans run at a variable speed using a VFD and the cooling duty is modulated with louvers.

In one embodiment, the refrigeration compressor(s) run at a fixed speed and fixed displacement.

In another embodiment, the refrigeration compressor(s) run at a variable speed using a VFD and with fixed displacement.

In another embodiment, the refrigeration compressor(s) run at a fixed speed with variable displacement through use of a slide valve.

In another embodiment, the refrigeration compressor(s) run at a variable speed using a WI) and with variable displacement using a slide valve.

An example of fuel gas output with various raw gas composition input is shown in Table 1.

TABLE 1
All cases inlet flow Mscfd 5000

| Gas sample | | 1 | 2 | 3 | 4 | 5 | 6 |
|---|---|---|---|---|---|---|---|
| Input HHV | | 1183 | 1201 | 1315 | 1372 | 1400 | 1450 |
| Input LHV | | 1073 | 1090 | 1194 | 1249 | 1274 | 1321 |
| Input Cat methane number | | 49.9 | 53.4 | 52.6 | 32.4 | 34.4 | 29.6 |
| Lean gas econ. HX | kW | 112 | 109 | 93 | 100 | 88 | 85 |
| Refrig. duty to −25 C. | kW | 142 | 141 | 158 | 192 | 184 | 201 |
| NGL vaporizing cooling | kW | 194 | 188 | 229 | 276 | 283 | 306 |
| Total Refrigeration Duty | kW | 447.7 | 438.3 | 479.5 | 567.6 | 554.5 | 591.9 |
| Lean gas produced at | | | | | | | |
| pressure | bar-abs. | 30 | 30 | 30 | 30 | 30 | 30 |
| min process temperature | C. | −35 | −35 | −35 | −35 | −35 | −35 |
| Output HHV | Btu/scf | 1022 | 1056 | 1132 | 1055 | 1140 | 1142 |
| Output LHV | Btu/scf | 924 | 955 | 1024 | 955 | 1031 | 1033 |
| Output Cat methane number | | 70.9 | 70.7 | 70.9 | 69.2 | 67.7 | 67.5 |
| flow rate | Mscfd | 4340 | 4375 | 4168 | 3717 | 3730 | 3512 |

While one skilled in the art can envision numerous embodiments the instant invention anticipates this.

The instant invention can alternatively be a system and a process to condition wellhead gas, or field gas, or gas from midstream gathering lines, or residue gas, or produced gas, by removing NGLs from the gas, such that the conditioned gas can be effectively used for fueling rotating equipment such as, compressors, generators, oil field equipment, fracking pump fleets or drilling rigs. The system can be comprised of:
a. a hydrate and freeze inhibition system, and,
b. an optional first refrigeration step using the cold output gas to pre-chill the incoming gas, and,
c. a second refrigeration step using a mechanical refrigeration system with an optional pre-cooled refrigerant reservoir and a flooded evaporator, and,
d. an optional third refrigeration step that flashes the condensed hydrocarbon liquids from the second refrigeration system further cooling the gas and condensing more hydrocarbon liquids, and,
e. an optional recycle system to route a slip stream from the conditioned gas back to the input of the system, and,
f. a control system.

The system of the instant invention can further be contained or mounted to a trailer on one or more trailer(s) or is built into one or more skid(s).

The system of the instant invention can further include where the refrigeration steps are selected, but not limited to, heat exchanger, evaporator, JT valve, turbo expander, or mechanical refrigeration.

The process of the instant invention can also incorporate an optional third step of refrigeration flashes the condensed hydrocarbon liquid stream rich in NGLs from the second refrigeration step through an expansion valve or a JT valve into a separator, where the separator may be selected from, but not limited to, vertical separator(s), horizontal separator(s), cyclonic separator(s), two-phase separator(s), three-phase separator(s), membrane separator(s), and/or absorption/desorption separator(s) and any combination thereof.

A process of the instant invention can also incorporate where the hydrate and freeze formation inhibition is done with antifreeze such as methanol liquid, or vaporized methanol, or with desiccant such as molecular sieve, or with glycols such as ethylene glycol (EG) and triethylene glycol (TEG).

A process of the instant invention can also incorporate where the refrigeration steps uses a commercial refrigerant such as propane (R290) or combination of refrigerants.

An apparatus of the instant invention can further include where the feed gas passes through an inlet filter to remove large particulate matter from the stream and an inline mixer mixes freeze suppressant/hydrate inhibitor with the feed stream.

The apparatus of the instant invention can further include where a kinetic hydrate inhibitor is pumped into a holding vessel and injected in liquid or vapor form into the system.

The apparatus of the instant invention can further include where the diverting valves and direct freeze suppressant/hydrate inhibitor to different areas in the process.

The apparatus of the instant invention can further include where the flow control valves continuously modulate based on process freeze suppression/hydrate inhibition requirements.

The apparatus of the instant invention can further include where the flow control valves are set at a fixed value and deliver a specified amount of freeze suppressant/hydrate inhibitor.

The apparatus of the instant invention can further include where the mixed stream enters the tube side of a shell and tube heat exchanger, where it is cooled by incoming NGLs on the shell side.

The apparatus of the instant invention can further include where the mixed stream enters the hot side of a plate heat exchanger and is cooled by incoming NGLs on the cold side.

The apparatus of the instant invention can further include where the cooled feed enters a phase separator where liquid and aqueous phases are metered through a level control valve into a low-pressure residue phase separator. The vapor phase leaving the phase separator mixes with freeze suppressant/hydrate inhibitor. An inline mixer shortens the required mixing length. The mixed stream is cooled by cold conditioned gas in a heat exchanger. The cooled stream is further cooled by a mechanical refrigeration system in an evaporator.

The apparatus of the instant invention can further include where the refrigeration evaporator is a flooded evaporator to thermally ground the evaporator hot side, reducing temperature and gas quality fluctuations and help recover from upset conditions.

The apparatus of the instant invention can further include where the refrigeration system generates an inventory of low-pressure liquid refrigerant by continuously operating in the absence of an external load.

The apparatus of the instant invention can further include where the refrigerant is vaporized by circulating hot refrigerant from the compressor discharge through the cold low-pressure refrigerant in the absence of load or is vaporized using an electric immersion heater in the holing vessel in absence of load.

The apparatus of the instant invention can further include where the control system varies cooling duty in response to process load and the refrigeration system uses compressors with variable displacement and/or speed.

The apparatus of the instant invention can further include where the refrigerant is stored as a liquid for transportation on board the system or is shipped independently when the system is relocated.

The apparatus of the instant invention can further include where the refrigerated gas is further cooled by evaporating NGLs in a heat exchanger. The cooled stream is separated in a phase separator. NGLs flow through a level control valve to a lower pressure where they are used to cool the refrigerated gas stream. Remaining cold NGLs proceed to the feed heat exchanger where they cool the feed gas stream. The remaining two-phase mixture flows into a low-pressure residue phase separator.

The apparatus of the instant invention can further include where an expansion valve decreases the process gas pressure prior to final separation to improve gas quality on startup.

The apparatus of the instant invention can further include where the cold gas leaving the cold phase separator exchange against pre-chilled incoming gas in a heat exchanger. Warm conditioned gas flows through a pressure control valve to outlet as conditioned gas at a specified pressure.

The apparatus of the instant invention can further include where water in the low-pressure residue phase separator is removed through a level control valve. Remaining NGLs spill over a weir inside the phase separator to a heated section in the phase separator.

The apparatus of the instant invention can further include where the heater drives off volatile components in the NGLs as reside gas, which is metered through a pressure control valve to the residue gas outlet. Remaining non-volatile NGLs are removed through a level control valve and mixed with the wastewater stream.

The apparatus of the instant invention can further include where the heater does not heat the liquids and volatile NGLs remain in the liquid phase.

The apparatus of the instant invention can further include where the cooling duty performed on the process gas is recovered by a series of heat exchangers.

The apparatus of the instant invention can further include where the produced fuel gas is heated with one or more heaters chosen from electric heater or gas fired heater to reach a temperature favorable for gas engines.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system to condition gas by removing natural gas liquids from said gas, such that conditioned gas can be effectively used for fueling rotating equipment such as, compressors, generators, oil field equipment, fracking pump fleets or drilling rigs comprising:
a. an inlet mixer that mixes freeze suppressant or hydrate inhibitor into the feed stream;
b. at least one refrigeration system with at least one of the refrigeration systems being a mechanical refrigeration system with pre-cooled refrigerant reservoir and a flooded evaporator;
c. at least one phase separator to separate hydrocarbon liquid and aqueous phases from hydrocarbon vapor phase;
d. a recycle system to route a slip stream from the conditioned gas back to the input of the system; and
e. a control system.

2. The system of claim 1 wherein said conditioned gas forms a mixed gas stream.

3. The system of claim 1 wherein said gas is selected from the group consisting of wellhead gas, field gas, gas from midstream gathering lines, residue gas, and produced gas.

4. The system of claim 1 wherein said at least one refrigeration system comprises a first refrigeration step, second refrigeration step and a third refrigeration step.

5. The system of claim 4 wherein said at least one refrigeration system has a first refrigeration step using the cold output conditioned gas to pre-chill the incoming gas between 20 degrees C. to −20 degrees C.;

6. The system of claim 1 wherein said at least one refrigeration system has a second refrigeration step using a mechanical refrigeration system with an optional pre-cooled refrigerant reservoir and a flooded evaporator to chill the incoming gas between 0 degrees C. to −40 degrees C.;

7. The system of claim 1 wherein said refrigeration system has a third refrigeration step that flashes condensed hydrocarbon liquids from the second refrigeration system further cooling the gas and condensing more hydrocarbon liquids to between −20 degrees C. to −70 degrees C.;

8. The system of claim 1 wherein the system is mounted on at least one trailer.

9. The system of claim 1 wherein the system is mounted on at least one skid.

10. The system of claim 1 wherein said at least one refrigeration step is selected from the group consisting of a heat exchanger, an evaporator, a Joule Thomson valve, a turbo expander, and a mechanical refrigeration system.

11. A method of using the device of claim 1 wherein, the natural gas is conditioned by removing natural gas liquids from said natural gas forming a condition gas, the method comprising:
a. Step 1 said natural gas comprises a mix of hydrocarbon natural gas stream and said natural gas is mixed with a freeze suppressant and a hydrate inhibitor;
b. Step 1A the percentage of freeze suppressant can be selected from 0 to 100% and the percentage of the hydrate inhibitor can be selected from 0 to 100% of the hydrocarbon natural gas stream;
c. Step 2 comprises of passing said natural gas to at least one variable capacity refrigeration system;
d. Step 2a comprises of the said refrigeration system refrigerates a refrigerant gas converting it into liquid even before there is any natural gas flowing through the system;
e. Step 2b comprises of the said pre-cooled liquid is stored in a reservoir or a surge tank;
f. Step 2c where when natural gas flows through the system it exchanges heat with the refrigerant in a heat exchanger;
g. Step 2d where said natural gas causes the refrigerant in the heat exchanger to evaporate, transferring cooling duty to said natural gas;
h. Step 2e where additional refrigerant liquid from the reservoir is siphoned to the heat exchanger to replace the evaporated refrigerant faster than the speed at which the refrigeration system can react to change in said natural gas flow and refrigeration capacity demand, thereby providing consistent refrigeration capacity even if demand for refrigeration spikes quickly;
i. Step 2f when the initial refrigeration capacity demand spike is over the variable refrigeration system automatically adjust to provide enough refrigeration capacity needed to refrigerate the steady state demand;
j. Step 3 comprises of passing said refrigerated natural gas from Step 2 to at least one phase separator to separate liquid and aqueous phases from vapor phase;
k. Step 4 comprising of a slip stream from the said vapor phase that is circulated back to the inlet of the system to provide load and reduce the NGL content of the input gas when the demand for conditioned gas is low;
l. Step 6 the control system that controls the variable capacity refrigeration system used in steps a-k so as to remove said liquids from said natural gas.

12. The method of claim 11 wherein an additional step of refrigeration flashes the condensed hydrocarbon liquid stream rich in NGLs from the variable refrigeration step through an expansion valve or a Joule Thomson valve into at least one separator.

13. The method of claim 12 wherein said at least one separator is selected from the group consisting of a vertical separator, horizontal separator, cyclonic separator, two-phase separator, three-phase separator, membrane separator, an absorption/desorption separator and any combination thereof.

14. The method of claim 11 wherein the hydrate and freeze formation inhibition uses antifreeze.

15. The method of claim 14 wherein said antifreeze is selected from the group consisting of methanol liquid, vaporized methanol with desiccant such as molecular sieve, methanol liquid with glycols such as ethylene glycol (EG) and triethylene glycol (TEG).

16. The method of claim 11 wherein the refrigeration is selected from the group consisting of commercial refrigerant, propane refrigerant, R290 and combination of refrigerants.
